(19) United States
(12) Patent Application Publication
(10) Pub. No.: US 2013/0042253 A1
(43) Pub. Date: Feb. 14, 2013

(54) RESOURCE MANAGEMENT SYSTEM, RESOURCE MANAGEMENT METHOD, AND RESOURCE MANAGEMENT PROGRAM

(71) Applicant: Shinjiro Yagi, Minato-ku (JP)

(72) Inventor: Shinjiro Yagi, Minato-ku (JP)

(73) Assignee: NEC CORPORATION, Minato-ku, Tokyo (JP)

(21) Appl. No.: 13/642,702

(22) PCT Filed: Apr. 20, 2011
(86) PCT No.: PCT/JP2011/002310

§ 371 Date: Oct. 22, 2012

(30) Foreign Application Priority Data
May 6, 2010 (JP) 2010-106492

(51) Int. Cl. G06F 9/50

(52) U.S. Cl. 718/104

(57) ABSTRACT

A resource management system is provided which calculates a safety rate in such a manner that the amount of resources satisfying an SLA does not become excessive. Excess rate calculation means 52 calculates an achievement rate based on a desired value of quality and on a data group of actual measured values representing the level of quality actually measured by the system that should satisfy the SLA, and calculates an excess rate by subtracting a compliance rate from the achievement rate. Safety rate derivation means 53 calculates, using the excess rate, an amount of resources to be allocated to the system on the condition that the excess rate is zero, and calculates the safety rate based on the allocated amount of resources and on the amount of resources used by the system in a steady state per unit time.

### TECHNICAL FIELD

The present invention relates to a resource management system, a resource management method, and a resource management program for managing computer resources. More particularly, the invention relates to a resource management system, a resource management method, and a resource management program for preventing a state in which resources are allocated excessively.

### BACKGROUND ART

A service level agreement (referred to as the SLA hereunder) is an agreement on the quality and content of the service to be provided by a computer system, and is made between the service provider and the service recipient in the form of a contract or the like. Generally, the service provider (more specifically, the computer system administrator) offering the service using a computer system sets by intuition and experience the amount of computer resources necessary for adhering to the SLA. At this time, the administrator sets the amount of resources by taking a safety rate into consideration so that the resources will not become insufficient. For example, even when an appropriate amount of resources is estimated to be “F” upon evaluation of the computer system, the safety rate α is taken into account and F×(1+α) is determined as the necessary amount of resources. If α is 0.5, then an amount of resources being 1.5 times as large as the evaluated amount of resources is determined as the necessary amount of resources. Incidentally, the amount “F” may be calculated by determining beforehand a function of the necessary amount of resources of which the variable is the number of requests made per unit time, and by putting the number of requests per unit time into the function.

Also, the expression “setting the amount of resources” above signifies that the necessary amount of resources is allocated by the computer system.

Some of the items of which the quality is stipulated by the SLA may be subject to a compliance rate. The compliance rate is the rate of those of actual measured values that should satisfy the desired values of quality set by the SLA regarding each item of interest (e.g., elapsed time). For purpose of explanation, there may be assumed a case in which a compliance rate is stipulated for the elapsed time of a computer system that performs processing on request. For example, suppose that the elapsed time is stipulated to be three seconds or less on the condition (called A) that “the maximum request count is X per unit time,” and that the compliance rate for the elapsed time is stipulated to be, say, 90%. In this case, if 90% or more of the actual measured values of the elapsed time satisfy the desired value thereof (i.e., 3 seconds or less) with the condition A being met, then the SLA is considered satisfied despite the fact that the remaining measured values exceed the desired value. In the above example, “3 seconds or less” is the desired value of the elapsed time, and “90%” is the compliance rate.

Incidentally, the elapsed time is the time that elapses from the time the computer system starts executing a task in response to a request until the task is completed. In the following description, Elapsed Time will be given as “elapsed time.”

For example, Patent Document 1 cited below describes a technique for managing computer resources. A computer resource management support system described in the cited Patent Document 1 recovers resources if they become insufficient and, when the resources are sufficient, allocates the necessary amount of resources to each of a plurality of application programs based on SLA information.

### CITATION LIST

### Patent Literature

### Patent Document 1

JP-A-2008-293283 (paragraph 0006, etc.)

### SUMMARY OF INVENTION

### Technical Problem

When humans determine the amount of computer resources necessary for satisfying the SLA by taking safety rates into consideration, they tend to set a higher safety rate given that they are psychologically reluctant “not to leave resources insufficient for the computer system to operate.” In that case, larger amounts of resources are likely to be allocated. As a result, excessive amounts of resources tend to be set with regard to the SLA, and the ratio of resource utilization is likely to remain low.

It is therefore an object of the present invention to provide a resource management system, a resource management method, and a resource management program for calculating the safety rate in such a manner that the amount of resources for satisfying the SLA will not become excessive.

### Solution to Problem

According to the present invention, there is provided a resource management system including: excess rate calculation means for calculating an achievement rate based on a desired value of quality stipulated by a service level agreement and on a data group of actual measured values representing the level of quality actually measured by the system that should satisfy the service level agreement, the achievement rate being the rate of those of the actual measured values which satisfy the desired value, and for calculating an excess rate by subtracting from the achievement rate a compliance rate stipulated by the service level agreement, as the rate of those of the actual measured values which must satisfy the desired value; and safety rate derivation means for calculating, using the excess rate, an amount of resources to be allocated to the system on the condition that the excess rate is zero, and for calculating a safety rate based on the allocated amount of resources and on the amount of resources used by the system in a steady state per unit time.

Also according to the present invention, there is provided a resource management method including: calculating an achievement rate based on a desired value of quality stipulated by a service level agreement and on a data group of actual measured values representing the level of quality actually measured by the system that should satisfy the service level agreement, the achievement rate being the rate of those of the actual measured values which satisfy the desired value; calculating an excess rate by subtracting from the achievement rate a compliance rate stipulated by the service level agreement, as the rate of those of the actual measured values which must satisfy the desired value; and calculating, using the excess rate, an amount of resources to be allocated to the system on the condition that the excess rate is zero, and calculating a safety rate based on the allocated amount of resources and on the amount of resources used by the system in a steady state per unit time.

Further according to the present invention, there is provided a resource management program for causing a computer to perform a procedure including: an excess rate calculation process for calculating an achievement rate based on a desired value of quality stipulated by a service level agreement and on a data group of actual measured values representing the level of quality actually measured by the system that should satisfy the service level agreement, the achievement rate being the rate of those of the actual measured values which satisfy the desired value, and for calculating an excess rate by subtracting from the achievement rate a compliance rate stipulated by the service level agreement, as the rate of those of the actual measured values which must satisfy the desired value; and a safety rate derivation process for calculating, using the excess rate, an amount of resources to be allocated to the system on the condition that the excess rate is zero, and for calculating a safety rate based on the allocated amount of resources and on the amount of resources used by the system in a steady state per unit time.

### Advantageous Effects of the Invention

According to the present invention, it is possible to calculate the safety rate in such a manner that the amount of resources satisfying the SLA does not become excessive.

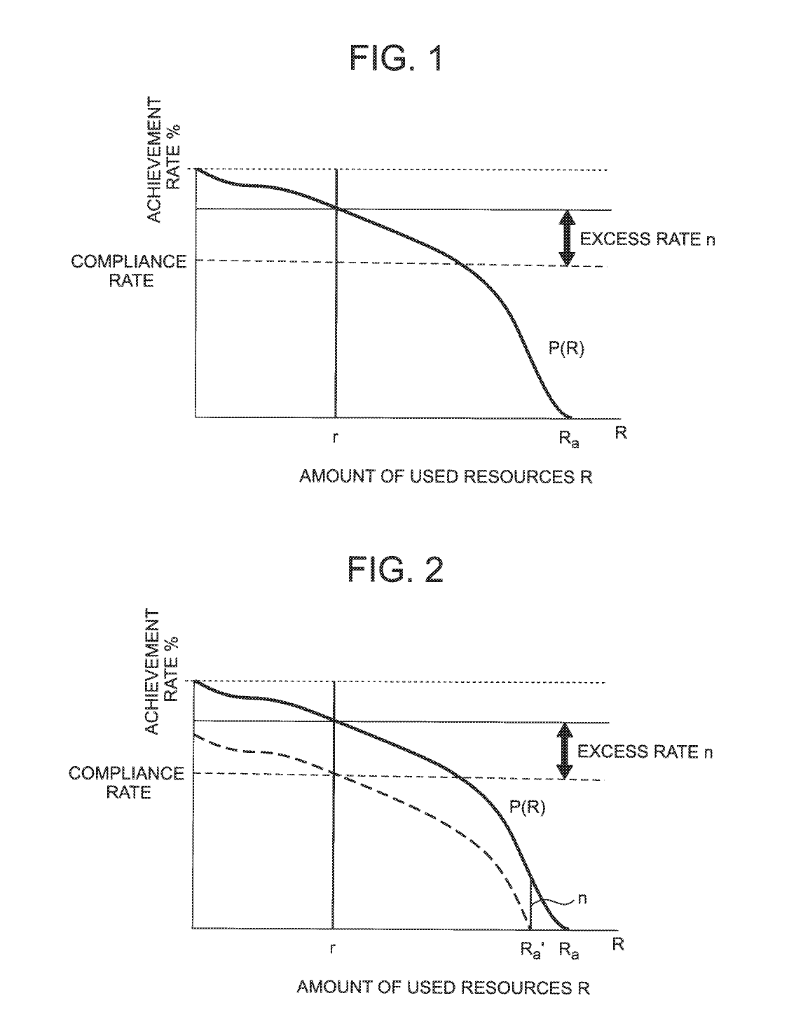

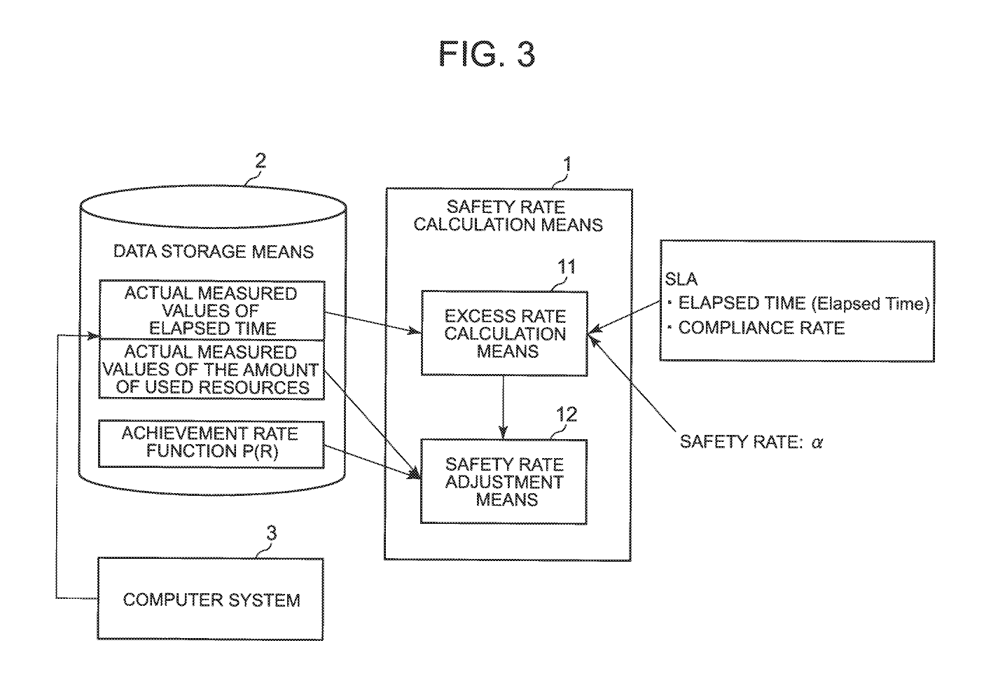

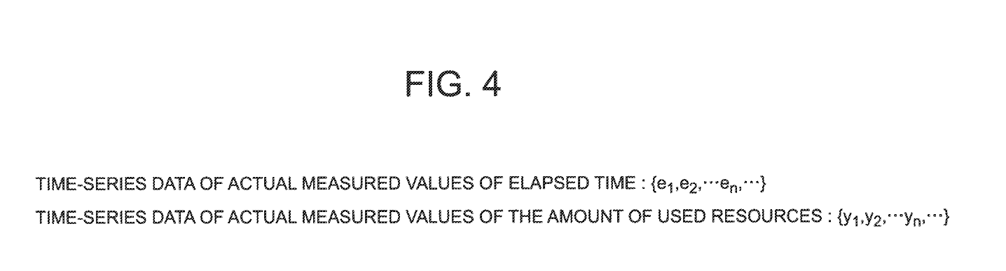

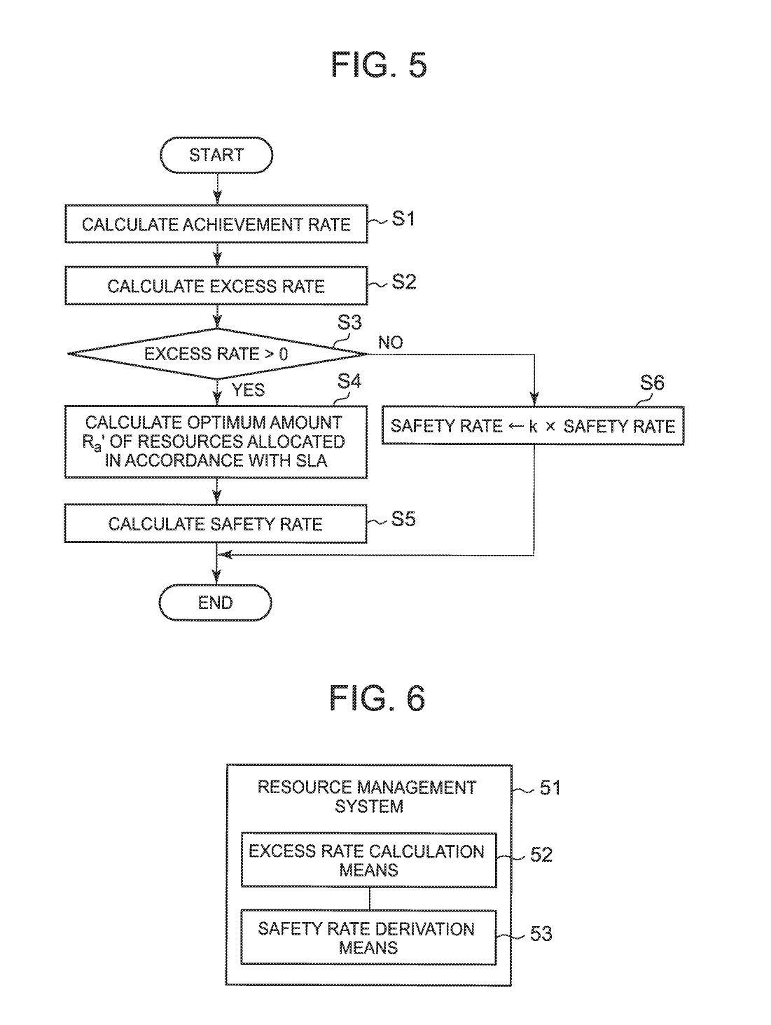

### BRIEF DESCRIPTION OF DRAWINGS

[FIG. 1] It depicts a graphic chart showing the relation between the amount of resources used in keeping with the number of requests per unit time on the one hand and an achievement rate on the other hand.

[FIG. 2] It depicts an explanatory chart showing the state in which the achievement rate is reduced overall by an excess rate n so that an achievement rate P(r) in a steady state becomes equal to a compliance rate.

[FIG. 3] It depicts a block diagram showing a resource management system as an exemplary embodiment of the present invention.

[FIG. 4] It depicts an explanatory chart showing an example of time-series data to be stored in data storage means 2.

[FIG. 5] It depicts a flowchart showing the typical course of processing according to the present invention.

[FIG. 6] It depicts a block diagram showing a typical minimum configuration of the resource management system according to the present invention.

### DESCRIPTION OF EXEMPLARY EMBODIMENTS

Some exemplary embodiments of the present invention will be explained below in reference to the accompanying drawings.

First of all, the processing according to the present is outlined hereunder.

It is assumed that a function is determined beforehand for the amount of resources per unit time regarding a computer system operated in a manner satisfying an SLA, the variable of the function being the number of requests made to the computer system. In the ensuing description, the function will be given as f(a), where “a” denotes the variable representing the number of requests made to the above-mentioned computer system per unit time. f(a) represents the amount of resources per unit time corresponding to the number of requests per unit time. It is also assumed that a maximum number of requests per unit time is stipulated beforehand by the SLA. The maximum number of requests per unit time stipulated by the SLA is given hereunder as aₘₐₓ. If the amount of resources necessary for satisfying the SLA (called the amount of necessary resources hereunder) is to be determined with a safety rate a taken into account, then the amount of necessary resources is expressed as f(aₘₐₓ)×(1+α). According to the present invention, an appropriate safety rate a is calculated in such a manner that resources are not allocated excessively.

Incidentally, the above-described function f(a) is a predetermined function. For example, f(a) may be derived beforehand using the least-square method or the like.

Also, it is assumed that “elapsed time” is included as an item for which a desired value of quality is stipulated by the SLA and that a compliance rate is determined with regard to elapsed time. It is further assumed that the maximum number of requests per unit time is determined beforehand and that the above-mentioned compliance rate is determined on the assumption that the number of requests per unit time does not exceed the maximum number of requests. As an example of the SLA regarding elapsed time, it may be stipulated that the desired value of elapsed time is to be three seconds on the condition that the maximum number of requests per unit time is 3000 Tx/S, and that the compliance rate of elapsed time is to be 90%. The unit “Tx/S” represents the number of requests per second. In this example, if at least 90% of actual measured values of elapsed time are within three seconds, then the SLA is considered satisfied. In other words, the SLA is satisfied if at least 90% of all requests fall within three seconds of elapsed time, with the remaining requests exceeding the three-second limit. That is, there is no need for all requests to fall within the elapsed time of three seconds.

Where the appropriate safety rate a is to be obtained according to this invention, the computer system is assumed to be operated in a steady state and the number of requests per unit time is assumed not to exceed the maximum count (3000 Tx/S in the above example) stipulated by the SLA.

The rate of the actual measured values satisfying the desired value stipulated by the SLA is called “achievement rate.” The achievement rate minus compliance rate is called excess rate. When the achievement rate is higher than the compliance rate, the excess rate becomes positive. For example, suppose that the compliance rate is determined to be 90% and that the rate of the actual measured values of elapsed time not exceeding three seconds (i.e., achievement rate) is 95%. In this case, the excess rate is 5% (=95%−90%).

FIG. 1 is a graphic chart showing the relation between the amount of resources used in keeping with the number of requests per unit time on the one hand and an achievement rate on the other hand. In FIG. 1, the vertical axis represents the achievement rate. The horizontal axis stands for the amount of resources used per unit time. The larger the number of requests per unit time, the larger the amount of used resources becomes. In addition, the larger the number of requests per unit time, the greater the load on the resources becomes. Thus, the achievement rate drops as the amount of used resources increases, as shown in FIG. 1. For example, as the number of requests per unit time rises, the amount of used resources and the load on the resources grow, which typically gives rise to a resource wait state and results in a lowered achievement rate. If the amount of used resources indicated on the horizontal axis is represented by R, then the achievement rate is expressed by a function P(R). The function P(R) is a previously furnished function. As such, the function P(R) may be derived beforehand using the least-square method or the like. The function P(R) is given as the achievement rate function.

In FIG. 1, reference character “r” denotes the amount of resources used in a steady state. The achievement rate P(r) corresponding to the amount of used resources minus the compliance rate provides an excess rate n (see FIG. 1). Also, reference character “Rₐ” in FIG. 1 represents the amount of resources used when the achievement rate becomes 0% following an increase in the number of requests per unit time. The amount “Rₐ” may be said to be the amount of resources in effect when all resources have been exhausted. Where “Rₐ” is set as the amount of computer system resources, it is possible to bring about the achievement rate P(r) in a steady state.

If P(r) is equal to the compliance rate, then it can be said that an optimum amount of resources satisfying the SLA is being set. However, in the example shown in FIG. 1, the achievement rate P(r) exceeds the compliance rate in a steady state. That is, in the example of FIG. 1, the amount of resources exceeds the optimum amount of resources, which constitutes a state in which excessive resources are allocated.

FIG. 2 shows the state in which the achievement rate is lowered overall by the excess rate n so that the achievement rate P(r) in a steady state become equal to the compliance rate. A broken line shows the state in which the achievement rate P(r) is lowered as a whole to become equal to the compliance rate. In the function expressed by this broken line, reference character Rₐ' represents the amount of resources used when the achievement rate is 0%. When the amount Rₐ' is established as the amount of resources set on the computer system, the achievement rate P(r) becomes equal to the compliance rate in a steady state. That is, it can be said that the amount Rₐ' is the optimum amount of resources to be set in accordance with the SLA.

The function indicated by broken line in FIG. 2 is obtained by lowering the function P(R) overall by the excess rate n. Thus the mathematical expression (1) below holds.

P(Rₐ′)−n=0 expression (1)

In the mathematical expression (1), “n” stands for the excess rate. Since the function P(R) is a known function, the optimum amount of resources can be calculated by calculating the excess rate n in a steady state and by solving the mathematical expression (1) for Rₐ′.

Further, if the number of requests per unit time in a steady state is given as N(Tx/S), then the amount R′ obtained by solving the mathematical expression (1) may be expressed by the mathematical expression (2) below.

f(N)×(1+α)=Rₐ′ expression (2)

When the mathematical expression (2) is solved for the safety rate a, it is possible to calculate the safety rate a for computing the optimum amount of resources.

In the mathematical expression (2), f(N) represents the amount of resources used per unit time in a steady state. Alternatively, an actually measured amount of resources used per unit time may be used as the amount of resources used per unit time in a steady state. As another alternative, f(N) may be calculating by substituting the number N of requests per unit time in a steady state into the variable a in the function f(a).

What follows is a specific explanation of the configuration of the resource management system and of the course of processing performed according to this invention. FIG. 3 is a block diagram showing a typical resource management system as an exemplary embodiment of the present invention. The resource management system of this invention includes safety rate calculation means 1 and data storage means 2.

The data storage means 2 is a storage device that successively stores the elapsed time on, and the amount of resources used by, a computer system 3 carrying out processing in response to requests. The data storage means 2 also stores a predetermined achievement rate function P(R). As explained above, the achievement rate function P(R) is a function of the achievement rate of which the variable is the amount R of used resources. For example, the achievement rate function P(R) may be defined beforehand using the least-square method or the like.

The safety rate calculation means 1 calculates the safety rate a for computing the optimum amount of resources of the computer system 3 based on the information stored in the data storage means 2 and on input data.

The computer system 3 is provided separately from the resource management system of the present invention, and performs its processing in response to the requests input to the computer system 3 itself. The resources determined as per the initial value of safety rate a are allocated to the computer system 3. Using the resources thus allocated, the computer system 3 performs its processing as requested. Also, the computer system 3 chronologically stores into the data storage means 2 the actual values of elapsed time of the processes carried out as requested and the actual values of the amount of resources used per unit time, as these values are measured over time. Further, the computer system 3 stores into the data storage means 2 the actual values of the number of requests per unit time as they are measured over time. In this case, the computer system 3 causes the actual measured values of the amount of resources used per unit time to be stored in association with the actual measured values of the number of requests per unit time.

The types of resources of which the set value is determined by the safety rate a include, and are not limited to, the CPU, memory, disk storage device, and communication network resources. In the case of the CPU, the amount of used resources may be expressed by the ratio of CPU utilization for example. In the case of the memory or disk storage device, the amount of used resources may be expressed by the ratio of memory utilization or of disk storage device utilization for example. As for the communication network resources, the amount of used resources may be expressed typically by the amount of data transmitted per unit time to an external router (not shown) over a communication network.

The computer system 3 chronologically stores into the data storage means 2 the actual measured values of elapsed time and the actual measured values of the amount of used resources. Thus in the data storage means 2, time-series data of the actual measured values of elapsed time as well as time-series data of the actual measured values of the amount of resources used per unit time are accumulated, as shown in FIG. 4. Since the computer system 3 also stores the actual measured values of the number of requests per unit time into the data storage means 2, the time-series data of the actual measured values of the number of requests per unit time (not shown in FIG. 4) are also accumulated. The individual values included in the time-series data of the amount of used resources and those included in the time-series data of the number of requests are associated with one another as the concurrently measured values.

Whereas the computer system 3 is operated in a steady state, the actual measured values of the amount of used resources are not always constant; they may well vary. For example, from the actual measured values of the amount of used resources, the safety rate calculation means 1 may select an optimum value.

The safety rate calculation means 1 includes excess rate calculation means 11 and safety rate adjustment means 12.

To the excess rate calculation means 11, the desired value of the elapsed time set for the computer system 3, the compliance rate, and the initial value of the safety rate a used to calculate the amount of resources of the computer system 3 in its initial state are input. The desired value and compliance rate of the elapsed time are values stipulated by the SLA. Incidentally, the SLA may define the maximum number of requests per unit time by stipulating, for example, that “the desired value of elapsed time is to be three seconds and the compliance rate of elapsed time is to be 90% on the condition that the maximum number of requests per unit time is 3000 Tx/S.” The computer system 3 is operated in a steady state, so that the number of requests per unit time does not exceed the maximum count stipulated by the SLA.

The excess rate calculation means 11 calculates the achievement rate by comparing the desired value of elapsed time with the time-series data of elapsed time stored in the data storage means 2 (see FIG. 4). In addition, the excess rate calculation means 11 calculates the excess rate n by subtracting an input compliance rate from the calculated achievement rate.

The safety rate adjustment means 12 solves the mathematical expression (1) for Rₐ′ using a predetermined achievement rate function P(R) and the excess rate calculated by the excess rate calculation means 11. Reference character Rₐ′ stands for the amount of resources optimally allocated in accordance with the SLA.

Furthermore, the safety rate adjustment means 12 solves the mathematical expression (2) for the safety rate a using the amount of resources used in a steady state and the amount Rₐ′ (amount of resources optimally allocated to the computer system 3). For example, the safety rate adjustment means 12 may obtain the amount of resources used per unit time from the time-series data of the amount of used resources and may use the value thus acquired as f(N) in the mathematical expression (2). Also, the number N of requests per unit time in a steady state is input beforehand to the safety rate adjustment means 12. The input number N is not an actual measured value; it may be the value stipulated by the SLA as “the maximum number of requests per unit time,” for example. In this case, the maximum number that may occur as the number of requests per unit time in a steady state is input as the number N.

The safety rate adjustment means 12 may select the optimum amount of resources used per unit time as follows: the safety rate adjustment means 12 selects the actual measured value of the amount of used resources corresponding to the actual measured value of the number of requests that is closest to the previously input number N (i.e., the maximum number of requests per unit time stipulated by the SLA in the above example). That is, the safety rate adjustment means 12 selects the actual value of the amount of used resources measured at the same time as that actual measured value of the number of requests that is closest to the previously provided N. The safety rate adjustment means 12 uses the selected actual measured value of the amount of used resources as f(N) in the mathematical expression (2).

If there are a plurality of actual measured values of the number of requests that are close to the previously input N, then the safety rate adjustment means 12 may calculate a mean value of those actual measured values of the amount of used resources which correspond to the actual measured values of the request count, and may use the mean value thus obtained as f(N) in the mathematical expression (2). That is, the safety rate adjustment means 12 may use as f(N) the mean value of the amount of used resources measured at the same time as the actual measured value of the number of requests that is close to the previously furnished N. Meanwhile, the safety rate adjustment means 12 may detect the actual measured value of the number of requests of which the difference from the input N falls within a predetermined threshold value as the actual measured value close to the number N.

Although the foregoing paragraphs have explained the case where the number N is input, it is also acceptable not to have the number N input. In such a case, the safety rate adjustment means 12 may calculate the value f(N) in the mathematical expression (2) as follows: given groups of K consecutive actual measured values from among the time-series data of the number of requests per unit time, the safety rate adjustment means 12 calculates the mean value of each group of K actual measured values. The mean value thus calculated is the number of requests per unit time in effect when attention is drawn to the time period defined by multiplying the unit time by a factor of K. For example, the number K may be input beforehand to the safety rate adjustment means 12. After calculating the mean value of each group of K consecutive actual measured values, the safety rate adjustment means 12 identifies the group of K consecutive actual measured values of which the mean value is the largest. The time period in which the identified K actual values were measured is a time period in which the number of requests per unit time was peaked in a steady state. The safety rate adjustment means 12 calculates the mean value of the actual values of the amount of used resources measured during that time period. Specifically, the safety rate adjustment means 12 may identify those actual measured values of the amount of used resources which correspond to the K consecutive actual measured values of the number of requests identified as explained above, before calculating the mean value of the identified actual measured values of the amount of used resources. The safety rate adjustment means 12 uses the mean value of the K actual measured values of the amount of used resources as f(N) in the mathematical expression (2).

Although the case in which the actual measured values are used as the amount of resources used per unit time has been explained as an example in connection with this exemplary embodiment, the safety rate adjustment means 12 may alternatively use a predetermined function f(a) in calculating the amount of resources used per unit time in a steady state. In this case, the safety rate adjustment means 12 calculates the mean value of the number of requests per unit time using the time-series data of the number of requests per unit time, and takes the mean value thus calculated as the number N of requests per unit time in a steady state. Then the safety rate adjustment means 12 may substitute the number N into the variable a of the function f(a) and solve the mathematical expression (2) for the safety rate u. At this time, the function f(a) may be input to the safety rate calculation means 1 from the outside. Alternatively, as with the achievement rate function P(R), the function f(a) may be stored beforehand in the data storage means 2.

When solving the mathematical expression (2) for the safety rate α, the safety rate adjustment means 12 may calculate the mathematical expression (3) below.

a={Rₐ′/f(N)}−1 expression (3)

Incidentally, if the calculated excess rate n is negative, then the safety rate adjustment means 12 raises the value of the input safety rate.

The safety rate calculation means 1 (specifically, the excess rate calculation means 11 and safety rate adjustment means 12) is implemented, for example, by the CPU of a computer operated in accordance with a resource management program. In this case, a program storage device (not shown) of the computer may store the resource management program, so that the CPU may act as the excess rate calculation means 11 and safety rate adjustment means 12 in keeping with the stored program. Alternatively, the excess rate calculation means 11 and the safety rate adjustment means 12 may each be implemented by an independent unit. It should be noted that the computer in this context is different from the computer system 3 shown in FIG. 3.

The operation is explained hereunder. FIG. 5 is a flowchart showing the typical course of processing according to the present invention. It is assumed that the computer system 3 has stored the time-series data of actual measured values of elapsed time and the time-series data of actual measured values of the amount of used resources into the data storage means 2. It is also assumed that the time-series data of actual measured values of the number of requests per unit time are stored in the data storage means 2. Further, it is assumed that the desired value of elapsed time (e.g., 3 seconds) and the compliance rate (e.g., 90%) stipulated by the SLA have been input to the excess rate calculation means 11, together with the initial value of safety rate cx. It is further assumed that the number N of requests per unit time in a steady state has been input to the safety rate adjustment means 12.

The excess rate calculation means 11 calculates the achievement rate by comparing the time-series data of actual measured values of elapsed time (see FIG. 4) stored in the data storage means 2 with the desired value of elapsed time (step S1). From among the individual actual measured values included in the time-series data of elapsed time, the excess rate calculation means 11 counts the number of the actual measured values that satisfy the desired value of elapsed time. For example, if the desired value of elapsed time is “3 seconds or less,” then the excess rate calculation means 11 counts the number of the actual measured values that do not exceed the three-second limit from among the values e₁, e₂, . . . , shown in FIG. 4. In addition, the excess rate calculation means 11 calculates as the achievement rate the rate of the number of the actual measured values satisfying the desired value relative to the number of all actual measured values.

From the achievement rate calculated in step S1, the excess rate calculation means 11 then subtracts the input compliance rate to calculate the excess rate n (step S2). The excess rate calculation means 11 transfers the calculated excess rate n and the initial value of the safety rate to the safety rate adjustment means 12.

The safety rate adjustment means 12 determines whether or not the excess rate calculated in step S2 is positive (step S3). If it is determined that the excess rate is positive (“YES” in step S3), then the safety rate adjustment means 12 proceeds to carry out step S4 and subsequent steps.

In step S4, the safety rate adjustment means 12 calculates the optimum amount Rₐ' of resources (see FIG. 2) to be allocated to the computer system 3 using the achievement rate function P(R) stored beforehand in the data storage means 2 and the excess rate n calculated in step S2 (step S4). That is, the safety rate adjustment means 12 solves the mathematical expression (1) for Rₐ′. Alternatively, with an inverse function P⁻¹ of P(R) stored beforehand in the data storage means 2, the safety rate adjustment means 12 may calculate P⁻¹(n) to obtain Rₐ′.

Next, the safety rate adjustment means 12 calculates the safety rate a for computing the optimum amount of resources, using the time-series data of the actual measured values of the amount of used resources stored in the data storage means 2 (see FIG. 4), the time-series data of the actual measured values of the number of requests per unit time (not shown in FIG. 4), and the amount Rₐ′ calculated in step S4 (step S5). Specifically, the safety rate adjustment means 12 selects that actual measured value of the amount of used resources which corresponds to the actual measured value of the number of requests that is closest to the previously input number N. The actual measured value of the amount of used resources corresponds to f(N) in the mathematical expressions (2) and (3). The safety rate adjustment means 12 may calculate the mathematical expression (3) to obtain the safety rate a by substituting the selected actual measured value of the amount of used resources into f(N) in the mathematical expression (3) and by substituting the value calculated in step S4 into Rₐ′. The safety rate a thus obtained is the safety rate for computing the optimum amount of resources for the computer system 3. After step S5, the resource management system terminates the processing. And as explained above, if there are a plurality of actual measured values of the number of requests which are close to the previously input number N, the safety rate adjustment means 12 may calculate the mean value of the actual measured values of the amount of used resources that correspond to the plurality of actual measured values of the number of requests, before substituting the mean value thus acquired into f(N) in the mathematical expression (3).

As another method for deriving f(N), given groups of K consecutive actual measured values from among the time-series data of the number of requests per unit time, the safety rate adjustment means 12 may calculate the mean value of each group of K actual measured values. The safety rate adjustment means 12 then identifies those actual measured values of the amount of used resources that correspond to the group of K consecutive actual measured values of which the mean value is the largest. The safety rate adjustment means 12 proceeds to substitute the mean value thus acquired into f(N) of the mathematical expression (3). In this case, the amount N need not be input.

If it is determined in step S3 that the excess rate is not positive (“No” in step S3), then the safety rate adjustment means 12 calculates a new safety rate a by multiplying the previously input initial value of the safety rate by a factor of k (step S6), before terminating the process. If the excess rate turns out to be zero, the safety rate adjustment means 12 terminates the processing without executing step S6. If the excess rate is negative, it means that the amount of resources allocated to the computer system 3 based on the initial value of the safety rate is insufficient. In such a case, the safety rate is increased by multiplying it by a factor of k so that a sufficient amount of resources may be allocated to the computer system 3. If the excess rate is zero, it means that an optimum safety rate is being set. In this case, the processing may be terminated without recalculating the safety rate.

According to this exemplary embodiment, when the achievement rate is higher than the compliance rate, an optimum amount of resources for the computer system 3 is calculating by having the amount of resources reduced by the quantity corresponding to the excess rate. The safety rate is then calculated in keeping with the optimum amount of resources thus computed. This makes it possible to obtain the safety rate that conforms to the compliance rate stipulated by the SLA. That is, the appropriate safety rate is obtained by preventing the derivation of a safety rate leading to the acquisition of an excess amount of resources.

Here is a comparison between the calculation of safety rate according to the present invention and the determination of safety rate by human intuition and experience. When humans determine safety rate based on intuition and experience, their psychological tendency “to avert insufficient resources” often leads to deciding on a higher safety rate than is necessary. As a result, an excess amount of resources tends to be allocated to the computer system 3. According to the invention, by contrast, it is possible to calculate the appropriate safety rate that conforms to the compliance rate without causing an excess amount of resources to be allocated as explained above. As long as the compliance rate is satisfied, the SLA is considered to be maintained even if some measured values of the elapsed time with regard to some requests have exceeded the applicable desired value.

The administrator of the computer system may recalculate the amount of resources to be allocated to the computer system 3 on the basis of the safety rate calculated in step S5 or S6, before allocating the resources to the computer system 3. This allocation process may be carried out by the resource management system.

The foregoing explanation of the flowchart has shown that actual measured values are used as the amount of used resources f(N). Alternatively, as explained above, the amount f(N) of used resources in a steady state may be calculated by substituting the number N of requests per unit time in a steady state into the variable a of the predetermined function f(a). In this case, the safety rate adjustment means 12 may calculate in step S5 the mean value of the actual measured values of the number of requests per unit time, and take the mean value thus calculated as the number N. Then the safety rate adjustment means 12 may calculate the safety rate a by computing the mathematical expression (3).

The flowchart of FIG. 5 has shown that the processing is terminated after step S5 or S6. Alternatively, the resource management system of the present invention may repeat step S1 and the subsequent steps at intervals of a predetermined time period in order to calculate the safety rate a repeatedly. In this case, the time-series data for each predetermined time period is used in step S2 or S5. For example, where the safety rate for a given time period is to be calculated, the excess rate calculation means 11 in step S1 calculates the achievement rate from the actual measured values of elapsed time over the time period in question. In step S5, the safety rate adjustment means 12 calculates the safety rate by selecting actual measured values from the time-series data of the amount of resources used in the time period of interest. Once the safety rate is calculated, the amount of resources to be allocated to the computer system 3 is recalculated from the calculated safety rate, and the calculated amount of resources is reflected on the computer system 3.

A minimum configuration of the present invention is explained next. FIG. 6 is a block diagram showing a typical minimum configuration of the resource management system according to the present invention. The resource management system 51 of this invention includes excess rate calculation means 52 and safety rate derivation means 53.

The excess rate calculation means 52 (e.g., excess rate calculation means 11 of this exemplary embodiment) calculates the achievement rate, i.e., the rate of the actual measured values satisfying the desired value, based on the relevant desired value of quality stipulated by the service level agreement (e.g., desired value of elapsed time) and on data groups of actual measured values (e.g., time-series data of elapsed time) representing the level of quality measured by a system (e.g., computer system 3) that should satisfy the service level agreement. The excess rate calculation means 52 proceeds to calculate the excess rate by subtracting from the calculated achievement rate the compliance rate stipulated by the service level agreement as the rate of the actual measured values that must satisfy the desired value.

The safety rate derivation means 53 (e.g., safety rate adjustment means 12), using the excess rate, calculates the amount of resources (e.g., Rₐ′) allocated to the system on the condition that the excess rate is zero. The safety rate derivation means 53 proceeds to calculate the safety rate based on the amount of the allocated resources and on the amount of resources used per unit time by the system in a steady state (e.g., f(N)).

Providing the above configuration makes it possible to calculate the safety rate in such a manner that the amount of resources satisfying the SLA will not become excessive.

The above-described exemplary embodiment has also disclosed the configuration in which the safety rate derivation means 53 calculates the safety rate by computing (T/U)−1 (e.g., by computing the mathematical expression (3)), where T denotes the amount of resources allocated to the system on the condition that the excess rate is zero, and U denotes the amount of resources used per unit time by the system in a steady state.

The above-described exemplary embodiment has also disclosed the configuration in which the safety rate derivation means 53 calculates the amount of resources allocated to the system on the condition that the excess rate is zero, by solving P(T)−n=0 for T, where R denotes the amount of resources used per unit time by the system that should satisfy the service level agreement, P(R) denotes the function of which the variable is R, and n denotes the excess rate.

The above-described exemplary embodiment has also disclosed the configuration in which the safety rate derivation means 53 uses actual measured values as the amount of resources used per unit time by the system in a steady state.

The above-described exemplary embodiment has further disclosed the configuration in which the safety rate derivation means 53 calculates the mean value of actual measured values of the number of requests made per unit time to the system in a steady state, and substitutes the obtained mean value into the function of the amount of resources used per unit time of which the variable is the number of requests per unit time, thereby obtaining the amount of resources used per unit time by the system in a steady state.

Part or all of what is provided as the above-described exemplary embodiment may be described in the supplementary notes below, but are not limited thereto.

(Supplementary note 1) A resource management system includes: an excess rate calculation unit for calculating an achievement rate based on a desired value of quality stipulated by a service level agreement and on a data group of actual measured values representing the level of quality actually measured by the system that should satisfy the service level agreement, the achievement rate being the rate of those of the actual measured values which satisfy the desired value, and for calculating an excess rate by subtracting from the achievement rate a compliance rate stipulated by the service level agreement, as the rate of those of the actual measured values which must satisfy the desired value; and a safety rate derivation unit for calculating, using the excess rate, an amount of resources to be allocated to the system on the condition that the excess rate is zero, and calculating a safety rate based on the allocated amount of resources and on the amount of resources used by the system in a steady state per unit time.

(Supplementary note 2) The resource management system described in supplementary note 1 above, wherein the safety rate derivation unit calculates the safety rate by calculating (T/U)−1, where T denotes the amount of resources allocated to the system on the condition that the excess rate is zero, and U denotes the amount of resources used by the system in a steady state per unit time.

(Supplementary note 3) The resource management system described in supplementary note 1 or 2 above, wherein the safety rate derivation unit calculates the amount of resources allocated to the system on the condition that the excess rate is zero, by solving P(T)−n=0 for T, where R denotes the amount of resources used per unit time by the system that should satisfy the service level agreement, P(R) denotes a function of the achievement rate of which the variable is the R, and n denotes the excess rate.

(Supplementary note 4) The resource management system described in any one of supplementary notes 1 through 3 above, wherein the safety rate derivation unit uses the values actually measured by the system as the amount of resources used by the system in a steady state per unit time.

(Supplementary note 5) The resource management system described in any one of supplementary notes 1 through 3 above, wherein the safety rate derivation unit obtains the amount of resources used by the system in a steady state per unit time, by calculating a mean value of the actually measured numbers of requests made to the system in a steady state per unit time and by substituting the mean value into a function of the amount of resources used per unit time, the variable of the function being the number of requests made per unit time.

It is to be understood that while the present invention has been described in conjunction with specific embodiments, it is evident that many alternatives, modifications and variations of the constitution and details of the invention will become apparent to those skilled in the art in light of the foregoing description. Accordingly, it is intended that this invention embrace all such alternatives, modifications and variations as fall within the spirit and scope of the appended claims.

The present invention contains subject matter related to that disclosed in Japanese Priority Patent Application JP 2010-106492 filed with the Japan Patent Office on May 6, 2010, the entire content of which is hereby incorporated by reference.

### INDUSTRIAL APPLICABILITY

The present invention may be applied advantageously to the calculation of the safety rate used for computing the amount of resources to be set on the computer system.

### REFERENCE SIGNS LIST

1 Safety rate calculation means
2 Data storage means
11 Excess rate calculation means
12 Safety rate adjustment means

1-9. (canceled)

10. A resource management system comprising:
an excess rate calculation unit for calculating an achievement rate based on a desired value of quality stipulated by a service level agreement and on a data group of actual measured values representing the level of quality actually measured by the system that should satisfy said service level agreement, said achievement rate being the rate of those of the actual measured values which satisfy said desired value, and for calculating an excess rate by subtracting from said achievement rate a compliance rate stipulated by said service level agreement, as the rate of those of the actual measured values which must satisfy said desired value, and
a safety rate derivation unit for calculating, using said excess rate, an amount of resources to be allocated to said system on the condition that said excess rate is zero, and for calculating a safety rate based on the allocated amount of resources and on the amount of resources used by said system in a steady state per unit time.

11. The resource management system according to claim 10, wherein said safety rate derivation unit calculates said safety rate by calculating (T/U)−1, where T denotes the amount of resources allocated to said system on the condition that said excess rate is zero, and U denotes the amount of resources used by said system in a steady state per unit time.

12. The resource management system according to claim 10, wherein said safety rate derivation unit calculates the amount of resources allocated to said system on the condition that said excess rate is zero, by solving P(T)−n=0 for T, where R denotes the amount of resources used per unit time by said system that should satisfy said service level agreement, P(R) denotes a function of said achievement rate of which the variable is said R, and n denotes said excess rate.

13. The resource management system according to claim 10, wherein said safety rate derivation unit uses the values actually measured by said system as the amount of resources used by said system in a steady state per unit time.

14. The resource management system according to claim 10, wherein said safety rate derivation unit obtains the amount of resources used by said system in a steady state per unit time, by calculating a mean value of the actually measured numbers of requests made to said system in a steady state per unit time and by substituting said mean value into a function of the amount of resources used per unit time, the variable of said function being the number of requests made per unit time.

15. A resource management method comprising:
calculating an achievement rate based on a desired value of quality stipulated by a service level agreement and on a data group of actual measured values representing the level of quality actually measured by the system that should satisfy said service level agreement, said achievement rate being the rate of those of the actual measured values which satisfy said desired value;
calculating an excess rate by subtracting from said achievement rate a compliance rate stipulated by said service level agreement, as the rate of those of the actual measured values which must satisfy said desired value, and
calculating, using said excess rate, an amount of resources to be allocated to said system on the condition that said excess rate is zero, and calculating a safety rate based on the allocated amount of resources and on the amount of resources used by said system in a steady state per unit time.

16. The resource management method according to claim 15, further comprising calculating said safety rate by calculating (T/U)−1, where T denotes the amount of resources allocated to said system on the condition that said excess rate is zero, and U denotes the amount of resources used by said system in a steady state per unit time.

17. A computer readable information recording medium storing a resource management program, when executed by a processor, performs a method for:
calculating an achievement rate based on a desired value of quality stipulated by a service level agreement and on a data group of actual measured values representing the level of quality actually measured by the system that should satisfy said service level agreement, said achievement rate being the rate of those of the actual measured values which satisfy said desired value;
calculating an excess rate by subtracting from said achievement rate a compliance rate stipulated by said service level agreement, as the rate of those of the actual measured values which must satisfy said desired value, and
calculating, using said excess rate, an amount of resources to be allocated to said system on the condition that said excess rate is zero, and calculating a safety rate based on the allocated amount of resources and on the amount of resources used by said system in a steady state per unit time.

18. The computer readable information recording medium storing a resource management program according to claim 17, wherein when executed by the processor, performs the method, further comprising calculating said safety rate by calculating (T/U)−1, where T denotes the amount of resources allocated to said system on the condition that said excess rate is zero, and U denotes the amount of resources used by said system in a steady state per unit time.
